(19) United States
(12) Patent Application Publication
(10) Pub. No.: US 2026/0101997 A1
(43) Pub. Date: Apr. 16, 2026

(54) Foldable Step Stool

(71) Applicant: Jinfang Yang, Jiaxing (CN)

(72) Inventor: Jinfang Yang, Jiaxing (CN)

(21) Appl. No.: 18/916,712

(22) Filed: Oct. 16, 2024

(51) Int. Cl. A47C 12/00; E06C 1/393

(52) U.S. Cl. CPC A47C 12/00; E06C 1/393

(57) ABSTRACT

A foldable step stool is disclosed, which relates to the technical field of step stools, including at least two sets of platforms, and the platforms are rotationally connected by their adjacent ends. The step stool body is rotationally provided with support legs at both ends, and two adjacent sets of the support legs are fixedly connected by a cross bar. By rotationally connecting the two sets of the platforms, so that space occupied by the foldable step stool can be reduced after being folded, this is convenient for transferring and storing. Moreover, two ends of pulling rope are fixedly connected to the adjacent ends of the two platforms, which is convenient for transferring with the step stool body through the pulling rope after being folded, thereby improving the use effect.

### TECHNICAL FIELD

The present application relates to the technical field of step stools, and in particular to a foldable step stool.

### BACKGROUND

In various scenarios involving climbing high operations, construction workers usually need tools to assist climbing, and the construction step stool is a typical auxiliary climbing tool. Structurally, the construction step stool includes legs and a platform supported by the legs, the legs are stably supported on the ground, and the construction workers board the platform for construction operations.

A typical use of the construction step stool is the need for frequent position transfers according to different use scenarios, which puts forward and higher requirements on the transfer flexibility of the construction step stool. It is required that the construction step stool may be quickly and conveniently expanded and folded, and the volume may be reduced by shrinking and folding in the transfer state and the non-use state, so as to facilitate the transfer and storage. And when in the use scenarios, the construction step stool may be quickly put into position by conveniently unfolding the operation in order to provide a good assistance to the construction work.

Due to irrational structural design, the platform of the existing construction step stool can not be folded, which results in it still occupying a large space when not in use, and also is not easy to transfer and storage, affecting the use of the effect.

### SUMMARY

The present disclosure aims to provide a foldable step stool to address problems that the platform of the step stool in existing technologies cannot be folded, resulting in occupying a large space.

To achieve above objectives, the present disclosure adopts the following technical solutions.

In some embodiments of the present disclosure, a foldable step stool is provided, including at least two sets of platforms, and the platforms are rotationally connected by their adjacent ends. The step stool body is rotationally provided with support legs at both ends, and two adjacent sets of the support legs are fixedly connected by a cross bar.

To facilitate the folding and unfolding of a first platform and a second platform, preferably, the platforms include the first platform and the second platform, the first platform is fixedly provided with a first rotary plate at one end, the second platform is fixedly provided with a second rotary plate at one end. The first rotary plate is rotationally connected with the second rotary plate, and the first rotary plate is provided with a locating part for restricting rotation of the second rotary plate.

To keep the first platform and the second platform to be unfolded, preferably, the locating part includes a second elastic button, a housing of the second elastic button is fixedly provided on the first rotary plate, the second rotary plate is opened with a second through hole, and a telescopic end of the second elastic button is slidingly provided in the second through hole.

To facilitate the folding and unfolding of the support legs, preferably, each support leg is provided with a connecting plate at one end, the first platform and the second platform each is fixedly provided with an adapter plate at another end, the connecting plate is rotationally provided on the adapter plate. The adapter plate is fixedly provided with a limit plate, the limit plate is against the one end of the support leg, and the adapter plate is provided with a first elastic button for restricting rotation of the connecting plate.

Preferably, the support leg is slidably provided with an extension rod at another end, and one end of the extension rod away from the support leg is fixedly provided with an anti-slip mat.

More preferably, a telescopic chute is provided within the support leg, and the one end of the extension rod is slidably provided into telescopic chute. The extension rod is fixedly provided with a third elastic button, the support leg is provided with several groups of limit holes at equal spaces apart, and a telescopic end of the third elastic button is slidably provided into the limit holes.

Compared with the existing technologies, the foldable step stool of the present disclosure has at least the following beneficial effects.
1. The foldable step stool of the present disclosure, by rotationally connecting the two sets of the platforms, so that space occupied by the foldable step stool can be reduced after being folded, this is convenient for transferring and storing. Moreover, two ends of pulling rope are fixedly connected to the adjacent ends of the two platforms, which is convenient for transferring with the step stool body through the pulling rope after being folded, thereby improving the use effect.
2. The foldable step stool of the present disclosure, by slidably providing the extension rod at the other end of each support leg, it is convenient to adjust the height of the step stool body, making it suitable for a variety of occasions requiring height increase. And the cross bar fixedly provided between the support legs, which is convenient for the user to climb up and down and improves the use effect. Moreover, the anti-slip mat is fixedly provided on the extension rod, which can improve the anti-slip effect.

The other parts not covered in this device are the same as the existing technologies or can be realized by using the existing technologies, the foldable step stool of the present disclosure can reduce the space occupied after folding by connecting the two sets of the platforms in rotation, which is convenient for transferring and storing.

### BRIEF DESCRIPTION OF THE DRAWINGS

FIG. 1 shows a schematic diagram of a folded state of a foldable step stool in accordance with some embodiments of the present disclosure.

FIG. 2 shows a schematic diagram of an unfolded state of the foldable step stool in accordance with some embodiments of the present disclosure.

FIG. 3 shows another schematic diagram of the unfolded state of the foldable step stool in accordance with some embodiments of the present disclosure.

FIG. 4 shows a structural schematic diagram of an adapter plate of the foldable step stool in accordance with some embodiments of the present disclosure.

FIG. 5 shows a structural schematic diagram of a press cap of the foldable step stool in accordance with some embodiments of the present disclosure.

In the drawings, reference signs are as follows. 1. First platform, 101. Second platform, 2. Support leg, 201. Anti-slip mat, 202. Extension rod, 203. Connecting plate, 204. Cross bar, 3. Adapter plate, 301. Limit plate, 4. First rotary plate, 401. Second rotary plate, 5. First elastic button, 501. Second elastic button, 6. Press cap, 601. Rubber tape.

### DETAILED DESCRIPTION OF THE EMBODIMENTS

The technical solutions in the embodiments of the present disclosure will be clearly and completely described below in conjunction with the accompanying drawings, and it is obviously that the embodiments described are only a part of the embodiments of the present disclosure, and not all of them.

In the description of the present disclosure, it is to be understood that the terms “up”, “down”, “front”, “back”, “left”, “right”, “top”, “bottom”, “inner”, “outside” and the like indicating orientations or positional relationship are based on those shown in the accompanying drawings, and are intended only to facilitate the description of the present disclosure and also to simplify the description, but are not intended to indicate or imply that the device or element referred to must have a particular orientation, be constructed and operated with a particular orientation, and therefore are not to be construed as a limitation of the present invention.

### Embodiments

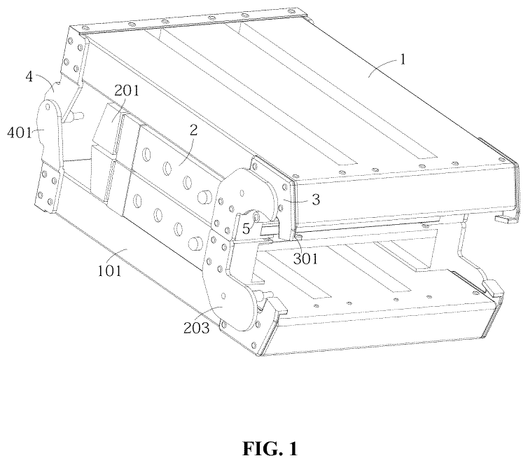

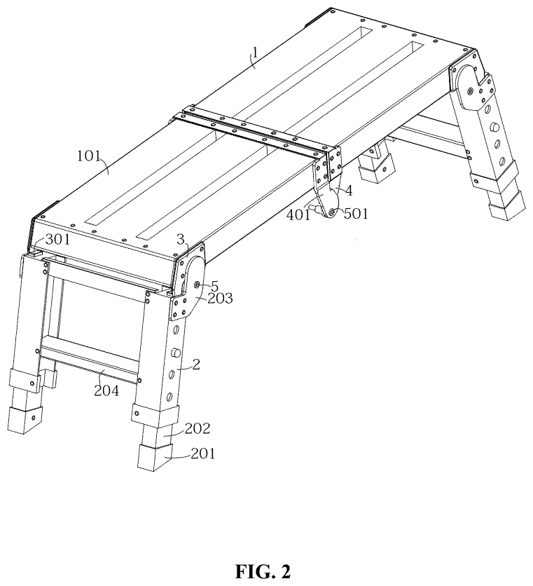

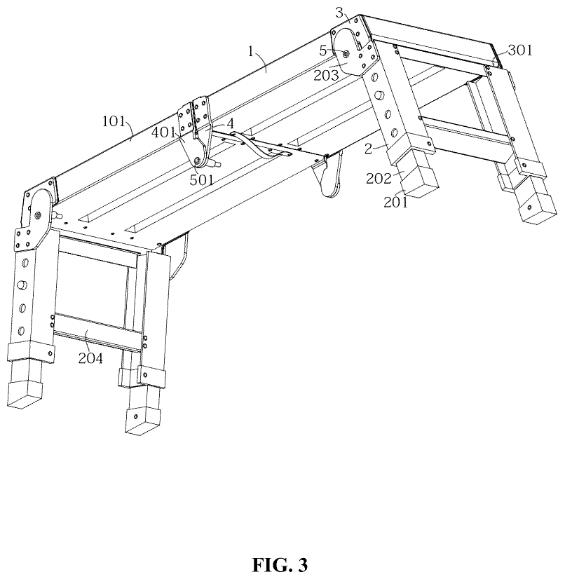

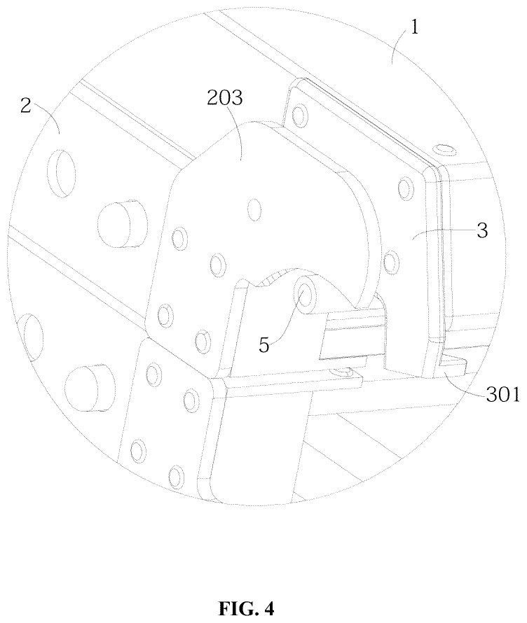

As shown in FIG. 1 to FIG. 5, in some embodiments of the present disclosure, a foldable step stool is provided, including a step stool body. The step stool body includes at least two sets of platforms, and the platforms are rotationally connected by their adjacent ends. Herein, the platforms are preferably in two sets of a first platform 1 and a second platform 101. The first platform 1 is fixedly provided with a first rotary plate 4 at one end, the second platform 101 is fixedly provided with a second rotary plate 401 at one end. The first rotary plate 4 is rotationally connected with the second rotary plate 401, and the first rotary plate 4 is provided with a locating part for restricting rotation of the second rotary plate 401. A pulling rope is fixedly provided at the adjacent ends between the first platform 1 and the second platform 101, that is to say, both ends of the pulling rope are fixedly connected to one end of the first platform 1 and the second platform 101 respectively, so that it is convenient to transfer the step stool body through the pulling rope after being folded to improve the use effect. Moreover, the step stool body is rotationally provided with support legs 2 at both ends, and two adjacent sets of the support legs 2 are fixedly connected by a cross bar 204. In other words, two sets of the support legs 2 located at the same end of the step stool body are fixedly connected by the cross bar 204, which can be used as a pedal to facilitate the use of personnel to climb up and down, thereby improving the use effect.

When in use, by rotationally connecting the first platform 1 with the second platform 101, so that the platforms of the step stool body have a folding effect, which can reduce the occupied space and facilitate the transfer and storage. Moreover, a second elastic button 501 is provided on the first rotary plate 4, and the second rotary plate 401 is provided with a second through hole, when the step stool body is unfolded, top surfaces of the two sets of the platform are in the same plane. At this time the second elastic button 501 is located in the second through hole, which can ensure that in the process of using, the two sets of the platform remain an unfolded state, avoiding be folded, which leads to the inability to use normally.

Referring to FIG. 1 to FIG. 3, the locating part may use bolts or pins, etc., to limit the rotation of the second rotary plate 401. Herein, the locating part includes a second elastic button 501, a housing of the second elastic button 501 is fixedly provided on the first rotary plate 4, the second rotary plate 401 is opened with the second through hole 501 corresponding to the second elastic button 501, and a telescopic end of the second elastic button 501 is slidingly provided in the second through hole. when the first platform 1 and the second platform 101 are in the unfolded state, the second elastic button 501 is just located in the second through hole, which can limit the rotation effect between the first rotary plate 4 and the second rotary plate 401, preventing the first platform 1 and the second platform 101 from being folded during use, resulting in failure of normal use, and improving the use effect.

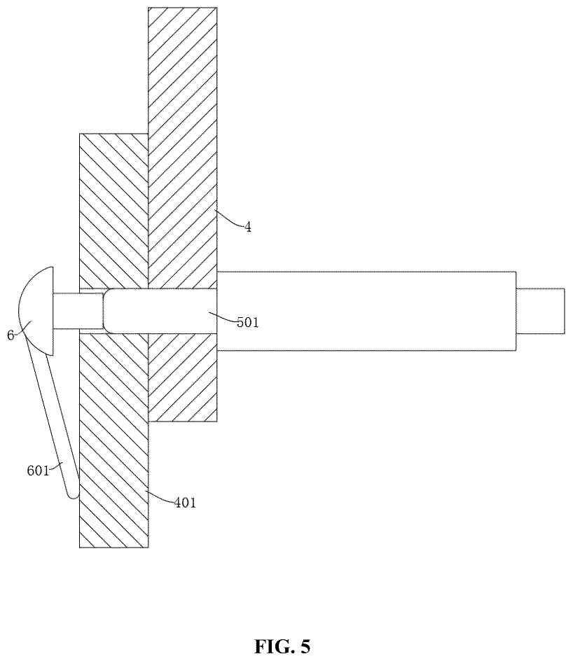

Referring to FIG. 5, to facilitate pressing the second elastic button 501, a press cap 6 is fixedly provided on the second rotary plate 401 by means of a rubber tape 601, and a top bar is fixedly provided on the press cap 6. One end of the top bar extends into the second through hole and is against the second elastic button 501. When in use, the second elastic button 501 can be driven to slide out from within the second through hole by means of the press cap 6, which is then convenient for folding. And the connecting plate 203 is likewise provided with the press cap 6, which facilitates pressing a first elastic button 5.

Referring to FIG. 1 to FIG. 4, each support leg 2 is provided with a connecting plate 203 at one end, the first platform 1 and the second platform 101 each is fixedly provided with an adapter plate 3 at another end, the connecting plate 203 is rotationally provided on the adapter plate 3. Moreover, the adapter plate 3 is fixedly provided with a limit plate 301, the limit plate 301 is against the top surface of one end of the support leg 2 to limit excessive rotation of the support leg 2, affecting the use. The adapter plate 3 is provided with the first elastic button 5 for restricting rotation of the connecting plate 203, and the connecting plate 203 is opened with a first through hole corresponding to the first elastic button 5. When in use, the support legs 2 are unfolded, both ends of the step stool body each is fixedly provided with the limit plate 301, one end of the support legs 2 is against the limit plate 301 to prevent the excessive rotation of the support legs 2, affecting the use effect. And when the support legs 2 are unfolded in place, that is, tops of the support legs 2 are against the limit plate 301, the first elastic button 5 is just located inside the through hole, which can prevent the support legs 2 from rotating during normal use, resulting in the inability to work properly, affecting the use of safety.

Referring to FIG. 1 to FIG. 3, each of the support legs 2 is slidably provided with an extension rod 202 at another end, and one end of the extension rod 202 away from the support leg 2 is fixedly provided with an anti-slip mat 201. The anti-slip mat 201 is plastic or rubber, preferably plastic. On the one hand, it can avoid scratching the ground, one the other hand, it can be fixedly provided with anti-slip texture at the bottom of the anti-slip mat 201, which can improve the anti-slip effect. By slidingly providing the extension rod 202 at the another end of the support leg 2, it is convenient to adjust the height of the step stool body, so as to make it applicable to a variety of occasions requiring height increase. The cross bar 204 is provided between two adjacent support legs 2, which is convenient for the user to climb up and down and improves the use effect. Moreover, the extension rod 202 is fixedly provided with the anti-slip mat 201, which can improve the anti-slip effect.

Referring to FIG. 1 to FIG. 3, a telescopic chute is provided within the support leg 2, and the one end of the extension rod 202 is slidably provided into the telescopic chute. The extension rod 202 is fixedly provided with a third elastic button, the support leg 2 is provided with several groups of limit holes at equal spaces apart, the limit holes are provided in two to ten groups, preferably five groups, and a telescopic end of the third elastic button is slidably provided into the limit holes. By sliding the extension rod 202 into the telescopic chute and providing the limit holes on the telescopic chute, on the one hand, it is convenient for the storage and extension of the extension rod 202 and reduces the occupied space, and on the other hand, when storing or unfolding, the extension rod 202 can be kept in its current state by means of the third elastic button, avoiding to be contracted during use, resulting in the inability to use it properly.

The forgoing is only some preferred specific embodiments of the present disclosure, but the scope of protection of the present invention is not limited thereto. And one of ordinary skill in the art who is familiar with the technical field of the present invention within the technical scope of the present invention, according to the technical solutions of the present disclosure and its inventive concept to be replaced or altered by the same, should be covered by the scope of protection of the present invention.

What is claimed is:

1. A foldable step stool, comprising a step stool body;
wherein the step stool body comprises at least two sets of platforms, and the platforms are rotationally connected by their adjacent ends; and
wherein the step stool body is rotationally provided with support legs at both ends, and two adjacent sets of the support legs are fixedly connected by a cross bar.

2. The foldable step stool according to claim 1, wherein the platforms comprises a first platform and a second platform, the first platform is fixedly provided with a first rotary plate at one end, the second platform is fixedly provided with a second rotary plate at one end; and wherein the first rotary plate is rotationally connected with the second rotary plate, and the first rotary plate is provided with a locating part for restricting rotation of the second rotary plate.

3. The foldable step stool according to claim 2, wherein the locating part comprises a second elastic button, a housing of the second elastic button is fixedly provided on the first rotary plate, the second rotary plate is opened with a second through hole, and a telescopic end of the second elastic button is slidingly provided in the second through hole.

4. The foldable step stool according to claim 2, wherein each support leg is provided with a connecting plate at one end, the first platform and the second platform each is fixedly provided with an adapter plate at another end, the connecting plate is rotationally provided on the adapter plate; and
wherein the adapter plate is fixedly provided with a limit plate, the limit plate is against the one end of the support leg, and the adapter plate is provided with a first elastic button for restricting rotation of the connecting plate.

5. The foldable step stool according to claim 4, wherein the support leg is slidably provided with an extension rod at another end, and one end of the extension rod away from the support leg is fixedly provided with an anti-slip mat.

6. The foldable step stool according to claim 5, wherein a telescopic chute is provided within the support leg, and the one end of the extension rod is slidably provided into the telescopic chute; and
wherein the extension rod is fixedly provided with a third elastic button, the support leg is provided with several groups of limit holes at equal spaces apart, and a telescopic end of the third elastic button is slidably provided into the limit holes.
